(19) United States
(12) Patent Application Publication
(10) Pub. No.: US 2017/0089545 A1
(43) Pub. Date: Mar. 30, 2017

(54) LED LAMP

(71) Applicant: STCUBE, INC., Seoul (KR)

(72) Inventor: Jae-Sul SON, Incheon (KR)

(21) Appl. No.: 14/933,098

(22) Filed: Nov. 5, 2015

(30) Foreign Application Priority Data
Sep. 30, 2015 (KR) 10-2015-0137655

(51) Int. Cl. F21V 9/08; F21V 17/12; F21V 19/00; F21V 17/00; F21V 23/00; F21V 29/80; F21K 99/00; F21V 17/06

(52) U.S. Cl. CPC F21V 9/08; F21K 9/1375; F21K 9/56; F21V 17/12; F21V 17/06; F21V 17/002; F21V 23/009; F21V 29/80; F21V 19/0055; F21Y 2101/02

(57) ABSTRACT

Provided is an LED lamp, which may include a filter which has a dome part, a flange having a plurality of protrusions or grooves formed at a predetermined distance from each other, and a cylindrical part having a screw thread formed on the outer circumferential surface thereof. The filter can be simply replaced or mounted by rotating the filter using the protrusions or grooves formed on the flange exposed to the outside. Thus, the LED lamp can easily convert light into white light having a color temperature desired by a user or various colors of light.

### INCORPORATION BY REFERENCE

This Application claims the benefit of priority to Korean Patent Application No. 10-2015-0137655 filed in the Korean Intellectual Property Office on Sep. 30, 2015, the entire content of which is hereby incorporated by reference.

### BACKGROUND

1. Technical Field

The present disclosure relates to an LED (Light Emitting Diode) lamp, and more particularly, to an LED lamp which is capable of easily converting light into white light at a color temperature desired by a user or various colors of light, and has high usability because the conversion can be effectively performed through a simple physical unit without a complex structure or control circuit.

2. Related Art

Since the late 1990's, various attempts have been made to apply the LED as lighting. During the period, remarkable achievements have been obtained, and the consumer recognition for LED lighting has been increased while the price and quality of the LED have been gradually improved. Therefore, they expect that the LED lighting market will rapidly grow by 30% or more on 2015 and the worldwide market scale will reach about 25.7 billion dollars.

Since the LED has high light conversion efficiency and low power consumption, the intensity and speed of light can be relatively easily controlled. Furthermore, since the LED has a small light source, the LED is suitable for reduction in size and weight. In addition, the LED has a long lifetime, includes a simple lighting circuit, has high resistance to impact, includes few environment pollution factors, reduces the fatigue of optic nerve, and realizes full colors. Thus, the LED is widely used for high-quality indoor/outdoor lightings. In particular, as a high-brightness LED capable of improving the low brightness problem of conventional LEDs is released on the market, the use of the high-brightness LED has rapidly expanded.

In particular, since white LEDs are very useful for high-quality indoor/outdoor lightings, the use frequency thereof has rapidly increased. Thus, they expect that the white LEDs will replace fluorescent lamps in no distant future in the same manner as the fluorescent lamps had removed incandescent lamps, and conquer the lighting market.

FIG. 8 illustrates a conventional LED lamp 1′ disclosed in Korean Patent No. 10-0759803 (registered on Sep. 12, 2007).

The LED lamp 1′ illustrated in FIG. 8 includes a driving unit 8a′, a heat sink 7′, a PCB (Printed Circuit Board) 8′, and a plurality of white LEDs 9′. The driving unit 8a′ is positioned in a main body 3′ formed of resin and serving as an outer cover having a lamp holder 2′ formed thereon, the heat sink 7′ is arranged on the top surface of the main body 3′, the PCB 8′ is positioned on the top surface of the heat sink 7′ with a thermally conductive insulating layer 7a′ interposed therebetween, and the plurality of white LEDs 9′ are mounted on the PCB 8′.

Furthermore, a light diffusion cover 6′ is arranged over the main body 3′, a reflecting plate 6a′ is positioned in the light diffusion cover 6′, and a plurality of heat radiation pins 7b′ for improving heat radiation are formed on the bottom surface of the heat sink 7′.

The conventional LED lamp 1′ is only designed to irradiate illumination light having a single color temperature in almost all cases, and has no unit capable of converting the illumination light into illumination light having a color temperature desired by a user.

In order to solve the problem of the conventional LED lamp, the present applicant has proposed an LED lamp 1″ having an aperture-type color temperature conversion filter 2″ mounted thereon as illustrated in FIG. 9. The LED lamp 1″ includes an LED light source module 3″ and a color temperature conversion module 4″. As the color temperature conversion module 4″ is rotated with respect to the LED light source module 3″, the opening area of the color temperature conversion filter 2″ can be adjusted to convert a color temperature.

However, since the conventional LED lamp 1″ has a complex structure for an aperture operation of the color temperature conversion filter 2″, the LED lamp 1″ requires a large number of parts and processes. Thus, the manufacturing cost inevitably increases.

### SUMMARY

Various embodiments are directed to an LED lamp which is capable of easily converting the color temperature of a single-color or white light LED having a specific single color temperature into white light having a color temperature desired by a user, without using a combination of LEDs having a plurality of color temperatures, thereby having high usability.

Also, various embodiments are directed to an LED lamp which is capable of easily implementing white light having a color temperature desired by a user through a simple physical unit without a complex structure or control circuit.

Also, various embodiments are directed to an LED lamp which is capable of easily obtaining white light having a desired color temperature from a high-brightness blue LED, purple LED, or UV LED which has a long lifetime and a low price, without using a high-brightness white LED which has a relatively short lifetime and a high price.

In an embodiment, an LED lamp may include: a main body housing a driving unit; a coupler supporting the driving unit and coupled to the main body; a heat sink fixed to the coupler; an LED module seated on the heat sink; a filter including a dome part, a flange having a plurality of protrusions or grooves formed at a predetermined distance from each other, and a cylindrical part having a screw thread formed on the outer circumferential surface thereof, and positioned to be separated from the LED module; a reflector including an opening having a screw thread formed on the inner circumferential surface thereof and screwed to the cylindrical part of the filter; and a holder housing the reflector and coupled to the heat sink, wherein the dome part and the flange of the filter are positioned to be exposed to the outside, and the filter is replaced or mounted by rotating the filter using the plurality of protrusions or grooves formed on the flange.

### BRIEF DESCRIPTION OF THE DRAWINGS

FIG. 1 is a top perspective view of an LED lamp according to an embodiment of the present invention.

FIG. 2 is a bottom perspective view of the LED lamp according to the embodiment of the present invention.

FIG. 3 is a side view of FIG. 1.

FIG. 4 is a side cross-sectional view of FIG. 1.

FIG. 5 is a top exploded view of FIG. 1.

FIG. 6 is a bottom exploded view of FIG. 1.

FIG. 7 is a diagram illustrating a filter replacing driver.

FIG. 8 is a side cross-sectional view of a conventional LED lamp.

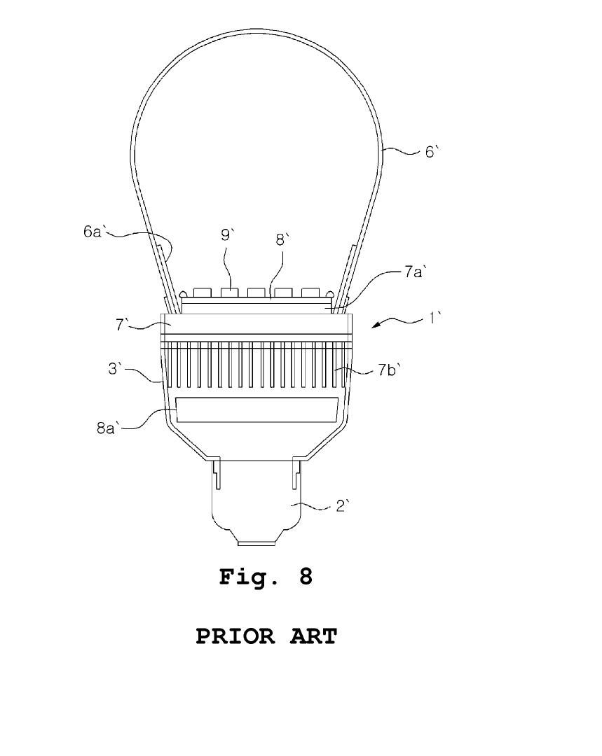

FIG. 9 is a perspective view of a conventional LED lamp for converting a color temperature by the present applicant.

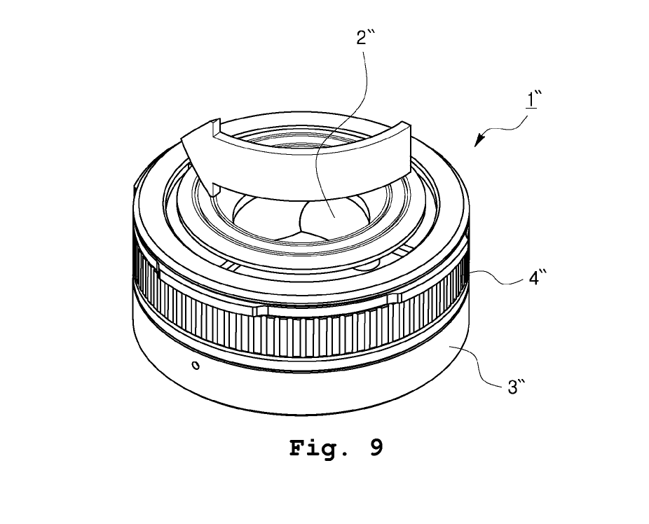

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

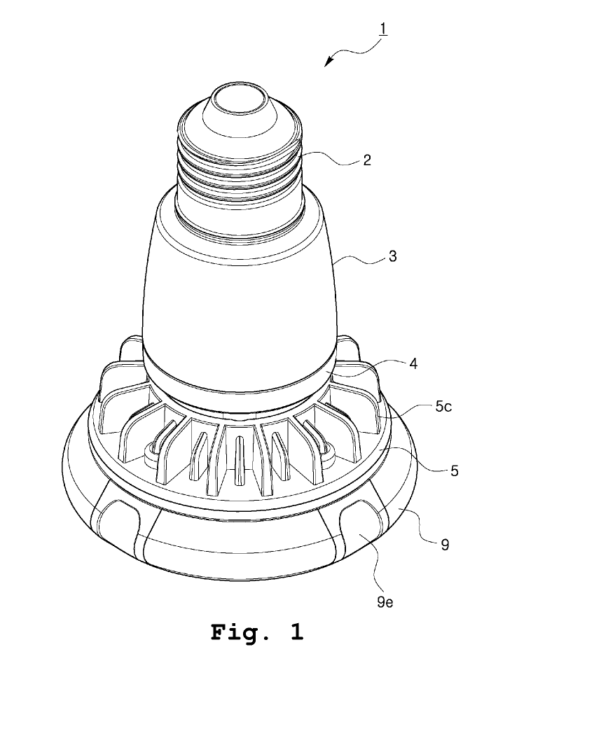

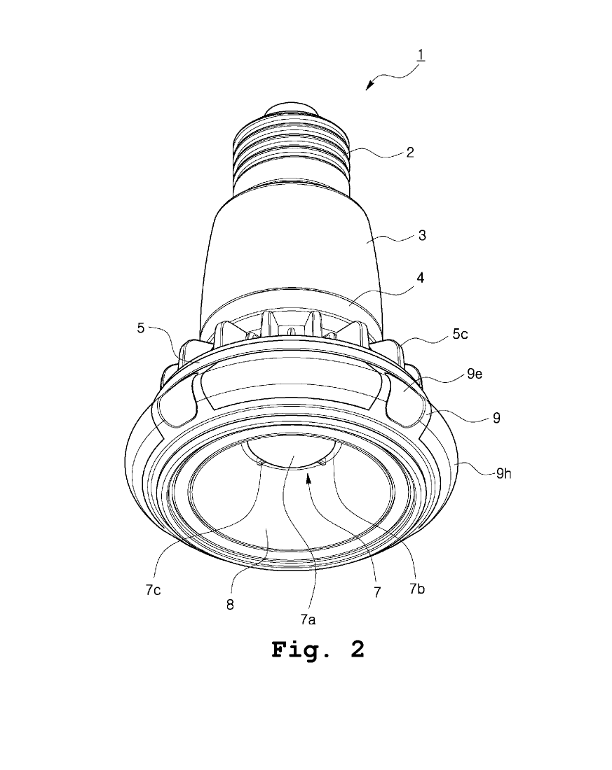

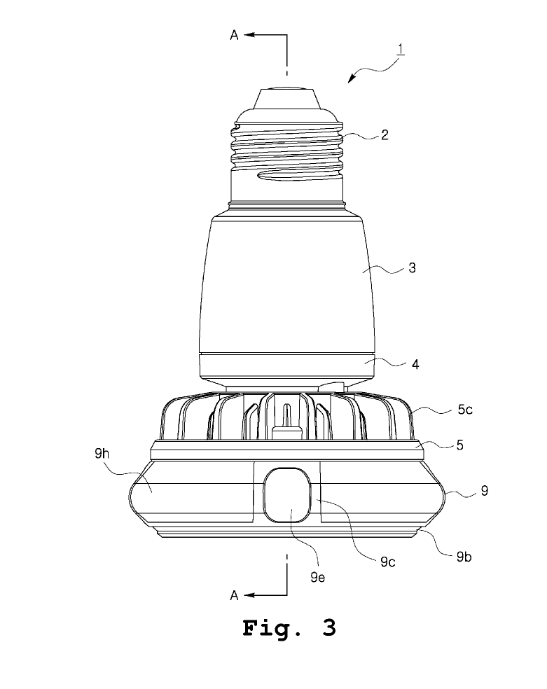

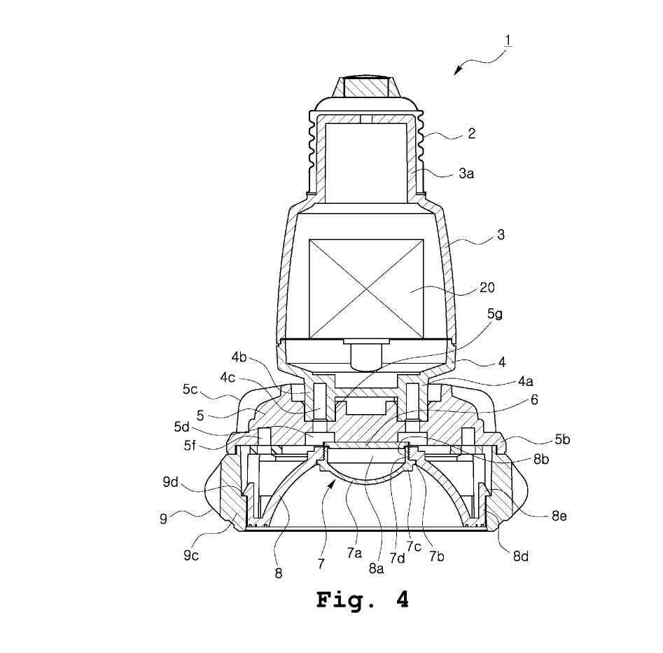

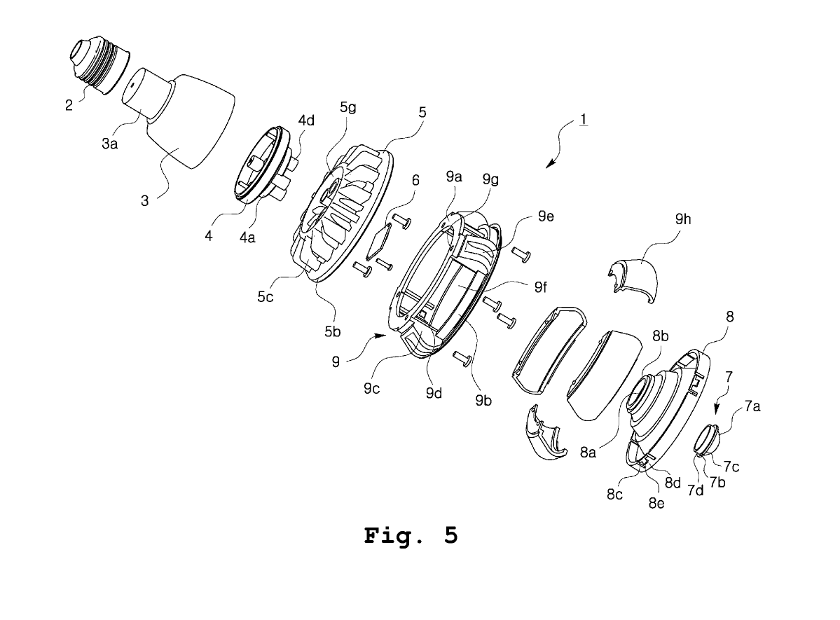

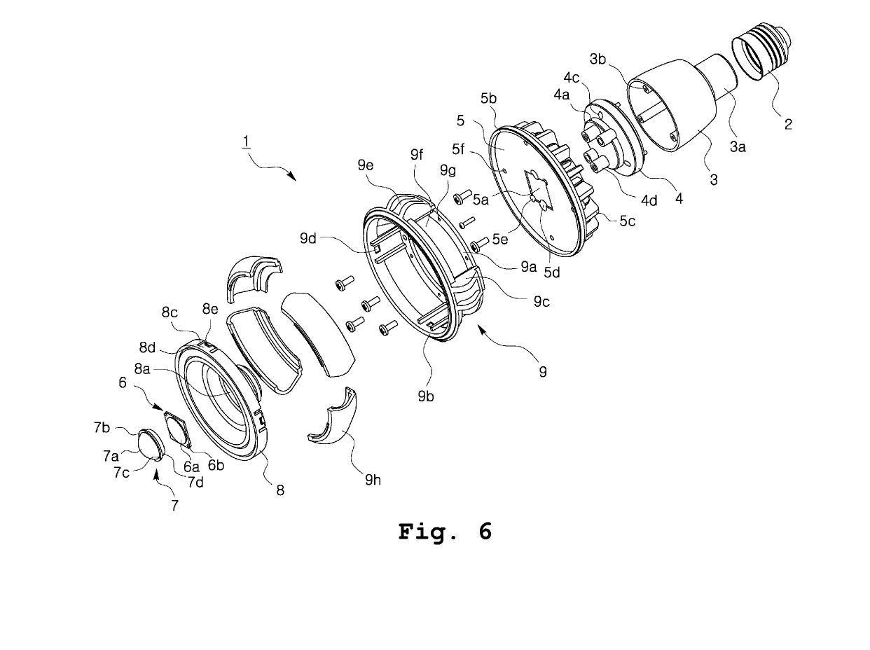

FIG. 1 is a top perspective view of an LED lamp 1 according to an embodiment of the present invention. FIG. 2 is a bottom perspective view of FIG. 1. FIG. 3 is a side view of FIG. 1. FIG. 4 is a side cross-sectional view of FIG. 1. FIG. 5 is a top exploded view of FIG. 1. FIG. 6 is a bottom exploded view of FIG. 1. Referring to FIGS. 1 to 6, the LED lamp 1 according to the embodiment of the present invention will be described as follows.

The LED lamp 1 according to the embodiment of the present invention includes a main body 3, a coupler 4, a heat sink 5, an LED module 6, a filter 7, a reflector 8, and a holder 9. The main body 3 houses a driving unit 20 therein. The coupler 4 supports the driving unit 20 and is coupled to the main body 3. The heat sink 5 is fixed to the coupler 4. The LED module 6 is seated on the heat sink 5. The filter 7 includes a dome part 7a, a flange 7b having a plurality of protrusions 7c or grooves positioned at a predetermined distance from each other, and a cylindrical part 7d having a screw thread formed on the outer circumferential surface thereof, and is positioned to be separated from the LED module 6. The reflector 8 includes an opening 8a having a screw thread formed on the inner circumferential surface and is screwed to the cylindrical part 7d of the filter 7. The holder 9 houses the reflector 8 and is coupled to the heat sink 5.

The dome part 7a and the flange 7b of the filter 7 are exposed to the outside through the reflector 8. The filter 7 can be easily replaced or mounted by rotating the filter 7 using the plurality of protrusions 7c or grooves formed on the flange 7b.

The drawings illustrate only the case in which the plurality of protrusions 7c are formed on the bottom surface of the flange 7b of the filter 7, but the present invention is not limited thereto. Depending on cases, a plurality of grooves may be formed instead of the plurality of protrusions 7c.

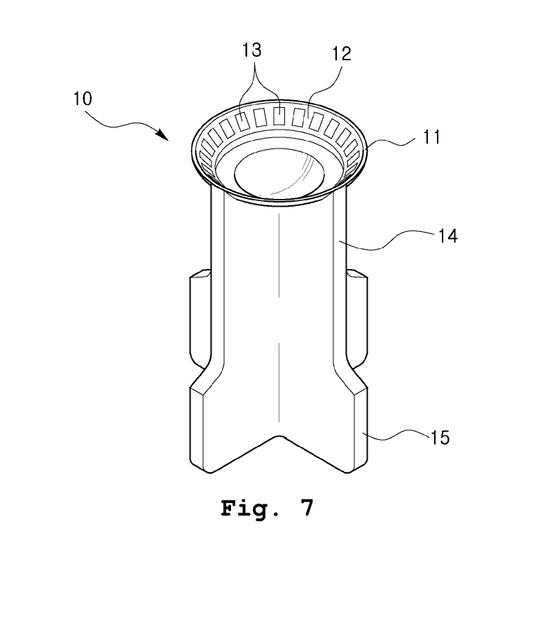

In order to replace or mount the filter 7 applied to the LED lamp 1 according to the embodiment of the present invention, the filter 7 may be rotated by a hand using the protrusions 7c or a driver 10 as illustrated in FIG. 7. The driver 10 will be described below with reference to FIG. 7.

The drawings illustrate the case in which a base mounting part 3a is formed on the main body 3 and a screw-type base 2 formed of nickel-plated brass is mounted on the base mounting part 3a, but the present invention is limited to the present invention. Depending on cases, a pin-type base may be applied.

The driving unit housed in the main body 3 may include an SMPS (Switching Mode Power Supply) which converts AC power into DC power.

The main body 3 includes a plurality of fixing parts 3b each having a fixing hole formed therein (refer to FIG. 6), and the coupler 4 has a plurality of fixing holes 4c formed therein. As the fixing parts 3b and the fixing holes 3c are connected through bolts (with no reference numeral), the coupler 4 is reliably coupled to the main body 3.

The main body 3, the reflector 8, and the holder 9 according to the embodiment of the present invention may be formed of heat-resisting reinforcing thermal conductive PBT (polybutylenterephthalate), PPA (polyphthalamide), or PPS (polyphenylene sulphide) resin containing glass fiber, carbon fiber, or carbon nanotube (CNT) at 5 to 25 volume% or desirably 5 to 15 volume%. However, the present invention is not limited thereto.

The coupler 4 includes an insertion part 4a having a plurality of protrusions 4b formed therein, the plurality of protrusions 4b having a fixing hole formed therein. The heat sink 5 has a convex part 5g and a plurality of fixing holes 5d. The insertion part 4a is seated on the top surface of the convex part 5g (refer to FIGS. 4 and 6), and the plurality of protrusions 4b are seated in the respective fixing holes 5d. As the fixing holes 5d of the heat sink 5 and the fixing holes (with no reference numeral) of the protrusions 4b of the coupler 4 are connected through bolts (with no reference numeral), the heat sink 5 is fixed to the coupler 4.

The coupler 4 and the heat sink 5 may be formed of any materials as long as the materials are light metals having excellent thermal conductivity. For example, the coupler 4 and the heat sink 5 may be formed of aluminum alloy or magnesium alloy. The heat sink 5 may have a plurality of heat radiation pins 5c arranged radially around the convex part 5g.

The drawings illustrate the case in which a heat radiation pin 5c having a large wing and a heat radiation pin 5c having a small wing are alternately arranged. However, the shapes or arrangements of the heat radiation pins are arbitrarily selected and not limited thereto.

The LED module 6 has a ring-shaped protrusion part 6a in which a plurality of LED chips (not illustrated) are mounted, and a quarter-circular indentation parts 6b formed at two diagonal corners of the LED module 6.

The heat sink 5 has an LED module seating part 5a and an LED module fixing hole 5e formed at the bottom surface thereof. As a bolt (with no reference numeral) is coupled to the LED module fixing hole 5e, the heat sink 5 is fixed to the coupler 4, and the two indentation parts 6b positioned in the diagonal direction are positioned on the bottom surface of the heat sink 5 in a state where the indentation parts 6b are reliably fixed through the bolts.

Furthermore, the heat sink 5 has a plurality of holder fixing holes 5f formed on the bottom surface thereof.

The holder 9 includes a lower frame 9a having the plurality of fixing holes 9g formed therein, a plurality of connection parts 9c, and an upper frame 9b, and the lower frame 9a, the connection parts 9c, and the upper frame 9b are integrated with each other.

As the holder fixing holes 9g of the lower frame 9a and the holder fixing holes 5f of the heat sink 5 are connected through bolts (with no reference numeral), the holder 9 is reliably fixed to the heat sink 5.

The rim (with no reference numeral) of the reflector 8 has a plurality of elastic pieces 8d each of which is formed by two grooves 8c, and each of the elastic pieces 8d has a coupling protrusion 8e formed thereon.

The holder 9 has a plurality of coupling bosses 9d formed on the inner surface of the connection part 9c of the holder 9. As the coupling protrusions 8e and the coupling bosses 9d are coupled to each other, the reflector 8 is mounted in the holder 9.

The drawings illustrate the case in which the reflector 8 has a multi-stage inclined structure. However, the reflector 8 may have a single-stage included structure or hemispherical structure.

Furthermore, the holder 9 has an arc-shaped opening 9f formed between the respective connection parts 9c, and a decoration piece 9h may be inserted and fixed to the arc-shaped opening 9f.

The PCB applied to the LED module 6 may include a publicly-known PCB. However, a single-layer or multilayer ceramic PCB having an excellent heat radiation property may be applied.

The LED applied to the LED module 6 may include any types of LEDs as long as the LEDs can be applied to lighting. For example, a white LED, a blue LED, a purple LED, a green LED, a red LED, a pink LED, or an arbitrary combination thereof may be applied. Typically, a pure white LED, a natural white LED, or a warm white LED may be applied.

Additionally, speaking for the filter 7, the filter 7 may be formed of translucent glass, transparent silicon, translucent silicon having minute uneven patterns formed thereof, or polycarbonate resin. In the embodiment of the present invention, the filter 7 may include a fluorescent substance for color conversion and perform a light diffusion lens function. The filter 7 may be formed in a bulb shape, a hemispherical shape, or a cylindrical shape. The shape may be referred to as the dome part 7a.

The filter 7 may not only perform a function of converting the LEDs 9 serving as a plurality of dot light sources into a surface light source, but also convert LED light into illumination light having a specific color temperature and a specific color.

In the present embodiment, the dome part 7a, the flange 7b, and the cylindrical part 7d having screw parts formed on the outer circumferential surface thereof may be integrated with each other. As publicly known, the filter 7 may include heat-resisting transparent resin of 65 to 99.9 wt % or desirably 82 to 99 wt % and a light-color-conversion fluorescent substance of 0.1 to 35 wt % or desirably 1.0 to 18 wt %. The fluorescent substance may convert light from various types of LED modules 6 into daylight white light having a color temperature of 5,000 to 8,000K, cool white light having a color temperature of 3,800 to 4,800, or warm white having a color temperature of 2,300 to 3,500. Since the function of the fluorescent substance is publicly known, the detailed descriptions thereof are omitted herein.

Furthermore, various organic and inorganic light diffusion substances may be selectively added to the filter 7, or various pigments may be selectively added to the filter 7 according to the preference such as illumination color. Since this operation is publicly known to those skilled in the art, the detailed descriptions thereof are omitted herein.

FIG. 7 is a diagram illustrating a filter replacing driver 10. Referring to FIG. 7, the filter replacing driver 10 includes a dish-shaped head 11, a cross-shaped body 14, and a plurality of leg parts 15. The dish-shaped head 11 has a plurality of grooves 13 formed in a ring shape along the inclined peripheral part 12 thereof.

In the LED lamp 1 according to the embodiment of the present invention, the dome part 7a and the flange 7b having the plurality of protrusions 7c formed at a predetermined distance from each other are exposed toward the reflector 8. Thus, as the filter 7 is rotated using the protrusions 7c, the cylindrical part 7d of the filter screwed to the screw thread formed on the inner circumferential surface 8b of the opening 8a of the reflector 8 is released to separate the filter 7. If necessary, a new filter 7 having a color temperature and/or color desired by a user can be simply mounted.

The rotation using the protrusions 7c may be performed by hand. However, when the above-described filter replacing driver 10 is used, the filter 7 can be conveniently separated. That is, the dish-shaped head 11 having the inclined peripheral part 12 on which the plurality of grooves 13 are formed in a ring shape may be placed on the flange 7b of the filter 7, the protrusions 7c may be inserted into the grooves 13, and the cross-shaped body 14 may be pressed and rotated to detach the filter 7.

FIG. 7 illustrates that the protrusions 7c are formed on the flange 7b of the filter 7 and the plurality of grooves 13 are formed in the inclined peripheral part 12 of the filter replacing driver 10. On the contrary, grooves may be formed in the flange 7b of the filter 7, and a plurality of protrusions may be formed on the inclined peripheral part 12 of the filter replacing driver 10.

The LED lamp 1 may be provided with a plurality of filters 7 having various color temperatures or colors and the filter replacing driver 10 as a set. Thus, a user may simply mount a filter 7 having a specific color temperature or color using the filter replacing driver 10 at a desired time, thereby realizing a desired atmosphere of lighting without buying a new LED lamp 1.

According to the embodiment of the present invention, the LED lamp can simply and easily convert the color temperature of a single-color or white LED having a specific single color temperature into white light having a color temperature desired by a user, without using a combination of LEDs having a plurality of color temperatures, thereby having high use convenience. Furthermore, the LED lamp can easily implement white light having a color temperature desired by a user through a simple physical unit without a complex structure or control circuit. Furthermore, the LED lamp can simply obtain white light having a desired color temperature from a high-brightness blue LED, purple LED, or UV LED which has a relatively long lifetime and a low price, without using a high-brightness white LED which has a relatively short lifetime and a high price.

While various embodiments have been described above, it will be understood to those skilled in the art that the embodiments described are by way of example only. Accordingly, the disclosure described herein should not be limited based on the described embodiments.

What is claimed is:

1. An LED lamp comprising:
a main body housing a driving unit;
a coupler supporting the driving unit and coupled to the main body;
a heat sink fixed to the coupler;
an LED module seated on the heat sink;
a filter comprising a dome part, a flange having a plurality of protrusions or grooves formed at a predetermined distance from each other, and a cylindrical part having a screw thread formed on the outer circumferential surface thereof, and positioned to be separated from the LED module;
a reflector comprising an opening having a screw thread formed on the inner circumferential surface thereof and screwed to the cylindrical part of the filter; and
a holder housing the reflector and coupled to the heat sink,
wherein the dome part and the flange of the filter are positioned to be exposed to the outside, and the filter is replaced or mounted by rotating the filter using the plurality of protrusions or grooves formed on the flange.

2. The LED lamp of claim 1, wherein the coupler comprises an insertion part having a plurality of protrusions formed thereon, the plurality of protrusions having a fixing hole formed therein,
the heat sink has a convex portion on which the insertion part is seated and fixing holes in which the protrusions are seated, and
the coupler and the heat sink are fixed to each other as the fixing holes of the heat sink and the fixing holes of the protrusions of the coupler are connected through bolts.

3. The LED lamp of claim 1, wherein the LED module comprises a ring-shaped protrusion part having a plurality of LED chips mounted thereon and indentation parts formed at two corners thereof in a diagonal direction,
the heat sink has an LED module seating part and an LED module fixing hole which are formed at the bottom surface thereof, and
the indentation parts in the diagonal direction are fixed to the bottom surface of the heat sink by a bolt connected through the LED module fixing hole.

4. The LED lamp of claim 1, wherein the coupler and the heat sink are formed of an aluminum or magnesium alloy, and the heat sink has a plurality of heat radiation pins formed around the convex part thereof.

5. The LED lamp of claim 1, wherein the heat sink has a plurality of holder fixing holes formed at the bottom surface thereof, and
the holder comprises a lower frame having a plurality of fixing holes formed therein, a plurality of connection parts, and an upper frame, and is fixed to the heat sink by bolts connected through the holder fixing holes and the fixing holes of the holder.

6. The LED lamp of claim 5, wherein the reflector comprises a rim having a plurality of elastic pieces formed therein, the plurality of elastic pieces each having a coupling protrusion formed therein and being formed by grooves,
the holder has a plurality of coupling bosses formed on the inner surface of the connection part thereof, and
the reflector is mounted in the holder as the coupling protrusions and the coupling bosses are coupled to each other.

7. The LED lamp of claim 5, wherein an arc-shaped opening is formed between the respective connection parts of the holder, and a decoration piece is inserted and fixed to the arc-shaped opening.

8. The LED lamp of claim 1, wherein the main body has a plurality of fixing parts formed thereon, the coupler has a plurality of fixing holes formed therein, and the main body and the coupler are coupled to each other by bolts connected through the fixing parts and the fixing holes.

9. The LED lamp of claim 1, wherein the main body has a base mounting part formed thereon, and a screw-type base is mounted on the base mounting part.
